(19) United States
(12) Patent Application Publication
(10) Pub. No.: US 2025/0106797 A1
(43) Pub. Date: Mar. 27, 2025

(54) METHOD AND APPARATUS FOR TRANSMITTING UPLINK SIGNAL IN NON-TERRESTRIAL NETWORK

(71) Applicant: ELECTRONICS AND TELECOMMUNICATIONS RESEARCH INSTITUTE, Daejeon (KR)

(72) Inventor: Hee Wook KIM, Daejeon (KR)

(73) Assignee: ELECTRONICS AND TELECOMMUNICATIONS RESEARCH INSTITUTE, Daejeon (KR)

(21) Appl. No.: 18/896,575

(22) Filed: Sep. 25, 2024

(30) Foreign Application Priority Data
Sep. 26, 2023 (KR) 10-2023-0129885

(51) Int. Cl. H04W 56/00; H04B 7/185

(52) U.S. Cl. CPC H04W 56/0045; H04B 7/18513

(57) ABSTRACT

A method of a terminal may comprise: receiving, from a base station, information on Timing Advance (TA) groups, which are divided into groups, each having a specific unit size, based on a range for TAs occurring within a cell, and information on group-specific scheduling offsets mapped to the TA groups; calculating a pre-compensated TA based on satellite ephemeris information of the base station and location information of the terminal; identifying a group-specific scheduling offset mapped to a TA group corresponding to the pre-compensated TA; and transmitting a first uplink signal including a preamble to the base station using an uplink timing adjusted based on the group-specific scheduling offset.

### CROSS-REFERENCE TO RELATED APPLICATIONS

This application claims priority to Korean Patent Application No. 10-2023-0129885, filed on Sep. 26, 2023, with the Korean Intellectual Property Office (KIPO), the entire contents of which are hereby incorporated by reference.

### BACKGROUND

### 1. Technical Field

The present disclosure relates to an uplink signal transmission technique in a non-terrestrial network, and more particularly, to an uplink signal transmission technique in a non-terrestrial network, in which a terminal receives timing information specific to the terminal from a base station and uses the timing information for uplink transmission.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such a communication network may provide communication services to terminals located on the ground, making it a terrestrial network (TN). Recently, there has been increasing demand for communication services not only for terrestrial entities but also for non-terrestrial entities such as unmanned aerial vehicles and satellites. In response to this, non-terrestrial network (NTN) technologies have been under discussion within the 3GPP. In an NTN, a base station may not be aware of an uplink timing that a terminal has pre-compensated. In this case, a terminal with a short propagation delay may intentionally add a delay, taking into account a propagation delay of terminals with longer delays. As a result, unintended artificial delays may occur in the NTN. To resolve this issue, the terminal may apply a terminal-specific offset to its uplink transmission timing. For this, the base station may obtain timing advance (TA) information from the terminal. In this case, additional procedures may be required for the base station to obtain TA information from the terminal. To accommodate these additional procedures, new resource(s) and channel(s) may need to be defined and added in both downlink and uplink.

### SUMMARY

The present disclosure for resolving the above-described problems is directed to providing a method and an apparatus for uplink signal transmission in a non-terrestrial network, which allow a terminal to receive terminal-specific timing information from a base station and to use the terminal-specific timing information for uplink transmission.

An uplink signal transmission method in a non-terrestrial network, according to a first exemplary embodiment of the present disclosure, as a method of a terminal, may comprise: receiving, from a base station, information on Timing Advance (TA) groups, which are divided into groups, each having a specific unit size, based on a range for TAs occurring within a cell, and information on group-specific scheduling offsets mapped to the TA groups; calculating a pre-compensated TA based on satellite ephemeris information of the base station and location information of the terminal; identifying a group-specific scheduling offset mapped to a TA group corresponding to the pre-compensated TA; and transmitting a first uplink signal including a preamble to the base station using an uplink timing adjusted based on the group-specific scheduling offset.

The specific unit size may be a unit of a random access preamble cyclic prefix (CP) length, slot length, or frame length.

The calculating of the pre-compensated TA may comprise: receiving the satellite ephemeris information from the base station; obtaining the location information of the terminal by receiving global positioning system (GPS) signals from GPS satellites; and calculating the pre-compensated TA using the satellite ephemeris information and the location information.

The transmitting of the first uplink signal may comprise: adjusting an uplink timing based on the group-specific scheduling offset to derive the adjusted uplink timing; generating the first uplink signal including the preamble; and transmitting the first uplink signal including the preamble to the base station using the adjusted uplink timing.

The method may further comprise: receiving information on preamble groups mapped to the TA groups from the base station, wherein the preamble may be a preamble selected from a preamble group mapped to the TA group among the preamble groups.

The method may further comprise: receiving a terminal-specific scheduling offset calculated based on the group-specific scheduling offset from the base station; and transmitting a second uplink signal to the base station using an uplink timing adjusted based on the terminal-specific scheduling offset.

An uplink signal transmission method in a non-terrestrial network, according to a second exemplary embodiment of the present disclosure, as a method of a base station, may comprise: grouping Timing Advances (TAs) occurring within a cell into TA groups, each having a specific unit size, based on a range of the TAs; generating group-specific scheduling offsets mapped to the TA groups; transmitting, to a terminal, information on the TA groups and information on the group-specific scheduling offsets mapped to the TA groups; and receiving, from the terminal, a first uplink signal including a preamble using an uplink timing adjusted based on the group-specific scheduling offset.

The specific unit size may be a unit of a random access preamble cyclic prefix (CP) length, slot length, or frame length.

The method may further comprise: identifying a position of a slot in which the first uplink signal is received; estimating the group-specific scheduling offset based on the identified position of the slot; calculating a terminal-specific scheduling offset based on the group-specific scheduling offset; and transmitting the terminal-specific scheduling offset to the terminal.

The method may further comprise: receiving, from the terminal, a second uplink signal using an uplink timing adjusted based on the terminal-specific scheduling offset.

The method may further comprise: grouping preambles used in the cell to generate preamble groups; mapping the preamble groups to the TA groups; and transmitting information on the preamble groups mapped to the TA groups to the terminal, wherein the preamble may be a preamble selected from a preamble group mapped to the TA group among the preamble groups.

The method may further comprise: identifying the preamble group including the preamble of the first uplink signal; estimating the group-specific scheduling offset based on the identified preamble group; calculating a terminal-specific scheduling offset based on the group-specific scheduling offset; and transmitting the terminal-specific scheduling offset to the terminal.

An uplink signal transmission apparatus in a non-terrestrial network, according to a third exemplary embodiment of the present disclosure, as a terminal, may comprise: a processor, and the processor may cause the terminal to perform: receiving, from a base station, information on Timing Advance (TA) groups, which are divided into groups, each having a specific unit size, based on a range for TAs occurring within a cell, and information on group-specific scheduling offsets mapped to the TA groups; calculating a pre-compensated TA based on satellite ephemeris information of the base station and location information of the terminal; identifying a group-specific scheduling offset mapped to a TA group corresponding to the pre-compensated TA; and transmitting a first uplink signal including a preamble to the base station using an uplink timing adjusted based on the group-specific scheduling offset.

In the calculating of the pre-compensated TA, the processor may further cause the terminal to perform: receiving the satellite ephemeris information from the base station; obtaining the location information of the terminal by receiving global positioning system (GPS) signals from GPS satellites; and calculating the pre-compensated TA using the satellite ephemeris information and the location information.

In the transmitting of the first uplink signal, the processor may further cause the terminal to perform: adjusting an uplink timing based on the group-specific scheduling offset to derive the adjusted uplink timing; generating the first uplink signal including the preamble; and transmitting the first uplink signal including the preamble to the base station using the adjusted uplink timing.

The processor may further cause the terminal to perform: receiving information on preamble groups mapped to the TA groups from the base station, wherein the preamble may be a preamble selected from a preamble group mapped to the TA group among the preamble groups.

The processor may further cause the terminal to perform: receiving a terminal-specific scheduling offset calculated based on the group-specific scheduling offset from the base station; and transmitting a second uplink signal to the base station using an uplink timing adjusted based on the terminal-specific scheduling offset.

The uplink signal transmission method according to the present disclosure can improve system performance while maintaining maximum compatibility with the existing NR/LTE system for a cell with a radius of 100 km or more. Additionally, the uplink signal transmission method according to the present disclosure can reduce a random access delay time artificially caused by a propagation delay difference between terminals within the cell in a non-terrestrial network based on satellites such as Geostationary Earth Orbit (GEO) and Low Earth Orbit (LEO) satellites. Furthermore, the uplink signal transmission method according to the present disclosure can implicitly report a timing advance in the idle mode without defining a new timing advance reporting procedure, thereby increasing the scheduling efficiency of the base station while reducing additional signaling overhead.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating a first exemplary embodiment of uplink slots in a non-terrestrial network.

FIG. 5 is a conceptual diagram illustrating a first exemplary embodiment of a propagation delay time difference in a non-terrestrial network.

FIG. 6 is a conceptual diagram illustrating a second exemplary embodiment of uplink slots in a non-terrestrial network.

FIG. 7 is a flowchart illustrating a first exemplary embodiment of a method for providing mapping information between TA group and preamble group to a terminal.

FIG. 8 is a flowchart illustrating a first exemplary embodiment of a method for transmitting an uplink signal in a non-terrestrial network.

FIG. 9 is a flowchart illustrating a first exemplary embodiment of a method for receiving an uplink signal in a non-terrestrial network.

FIG. 10 is a conceptual diagram illustrating a third exemplary embodiment of uplink slots in a non-terrestrial network.

FIG. 11 is a flowchart illustrating a first exemplary embodiment of a method for providing mapping information between a TA group and a group-specific K_{offset,group} to a terminal.

FIG. 12 is a flowchart illustrating a second exemplary embodiment of an uplink signal transmission method in a non-terrestrial network.

FIG. 13 is a flowchart illustrating a second exemplary embodiment of a method for receiving an uplink signal in a non-terrestrial network.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHZ. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

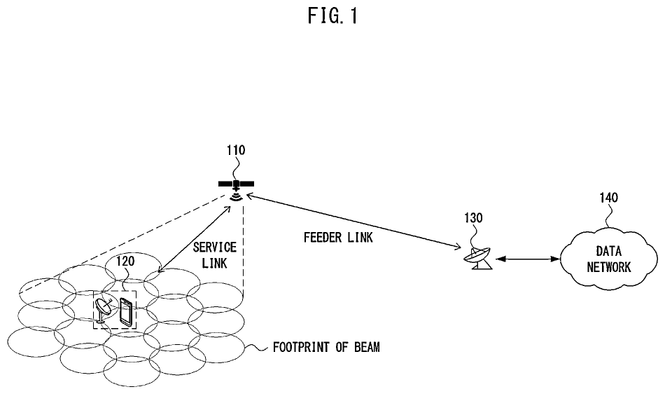

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

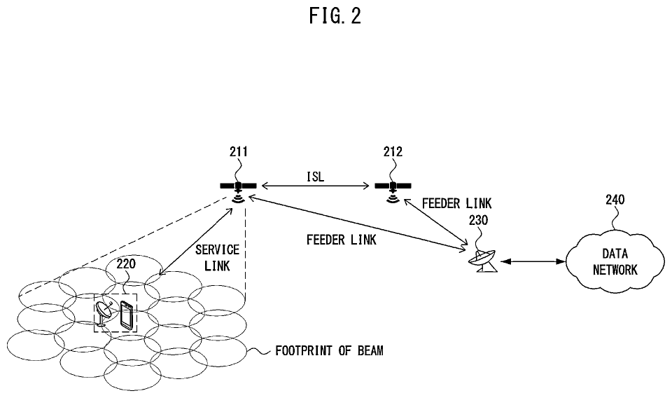

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SME, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

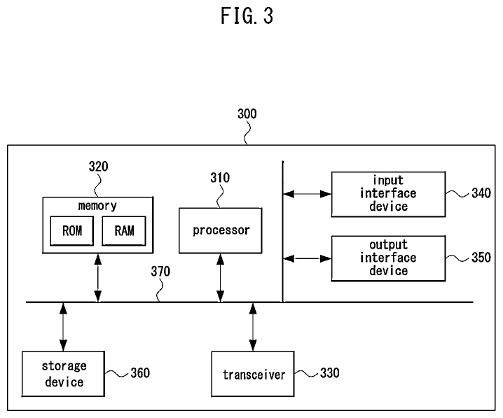

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | Scenarios C and D | |
|---|---|---|---|
| Altitude | 35,786 km | 600 km | |
| | | 1,200 km | |
| Spectrum (service link) | <6 GHz (e.g. 2 GHz) | | |
| | >6 GHz (e.g. DL 20 GHz, UL 30 GHz) | | |
| Maximum channel bandwidth | 30 MHz for band <6 GHz | | |
| capability | 1 GHz for band >6 GHz | | |
| (service link) | | | |
| Maximum distance between | 40,581 km | 1,932 km | (altitude of 600 km) |
| satellite and communication | | 3,131 km | (altitude of 1,200 km) |
| node (e.g. UE) at the minimum | | | |
| elevation angle | | | |
| Maximum round trip delay | Scenario A: 541.46 ms (service | Scenario C: (transparent | |
| (RTD) | and feeder links) | payload: service and feeder | |
| (only propagation delay) | Scenario B: 270.73 ms (only | links) | |
| | service link) | −5.77 ms | (altitude of 60 0 km) |
| | | −41.77 ms | (altitude of 1,200 km) |
| | | Scenario D: (regenerative | |
| | | payload: only service link) | |
| | | −12.89 ms | (altitude of 600 km) |
| | | −20.89 ms | (altitude of 1,200 km) |
| Maximum delay variation | 16 ms | 4.44 ms | (altitude of 600 km) |
| within a single beam | | 6.44 ms | (altitude of 1,200 km) |
| Maximum differential delay | 10.3 ms | 3.12 ms | (altitude of 600 km) |
| within a cell | | 3.18 ms | (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario | Scenario | Scenario | Scenario |
|---|---|---|---|---|
| | A | B | C1-2 | D1-2 |
| Satellite altitude | 35,786 km | | 600 km | |
| Maximum RTD in a | 541.75 ms | 270.57 ms | 28.41 ms | 12.88 ms |
| radio interface | (worst case) | | | |
| between base | | | | |
| station and UE | | | | |
| Minimum RTD in a | 477.14 ms | 238.57 ms | 8 ms | 4 ms |
| radio interface | | | | |
| between base | | | | |
| station and UE | | | | |

Meanwhile, it is expected that the mobile communication network beyond 5G will evolve in the direction of combining or cooperating with terrestrial networks and satellite networks (i.e. non-terrestrial networks (NTN)). In the integrated system of terrestrial and satellite networks, commonality between satellite and terrestrial radio interfaces may be very important when considering the cost of the terminals. Accordingly, the standardization of NR-based NTN is actively underway in the 3GPP. Moreover, in the 3GPP, the standardization and research of NTN radio interfaces based on NR/LTE/narrowband Internet of Things (NB-IoT) are progressing with consideration of characteristics such as long round-trip delay times compared to terrestrial mobile communication networks, differences in delay times between terminals, large cell coverage, and significant Doppler shifts between base stations and terminals, reflecting the delay time differences within the cell coverage and the power-limited satellite environment.

In this regard, the 3GPP NR/NTN Release 17 specifications have added a scheduling offset value K_{offset} to the 5G NR physical layer specifications to address the long round-trip delay time of satellite systems. In the existing NR specifications, a transmission timing of a Physical Uplink Shared Channel (PUSCH) may be adjusted by a Time Domain Resource Assignment (TDRA) field of Downlink Control Information (DCI) transmitted on a Physical Downlink Control Channel (PDCCH). The TDRA field may be used as an index of a Radio Resource Control (RRC) configuration table which provides information on a relative timing for when the PUSCH should be transmitted after receiving the associated PDCCH. Specifically, an uplink slot in which the terminal should transmit the PUSCH, based on the scheduling DCI received in a downlink slot n, may be a slot n+K₂. Here, n may be a positive integer, and K₂ may be a relative slot offset value for the downlink slot n. A range of K₂ value may be 0, 1, . . . , and 32.

In the case of NTN, each terminal may require a value larger than a Timing Advance (TA) value considered in the existing TN to compensate for the long round-trip delay time difference between the terminal and the base station. The relative slot offset value K₂ that can be used in the existing NR specifications may have difficulty in accommodating all TA values that should be considered in NTN considering its range. In other words, the slot n+K₂ in which the PUSCH is transmitted may occur before the slot n in which the scheduling DCI is received. To solve this issue, the Release 17 NTN specifications have introduced the scheduling offset K_{offset} to improve the PUSCH timing.

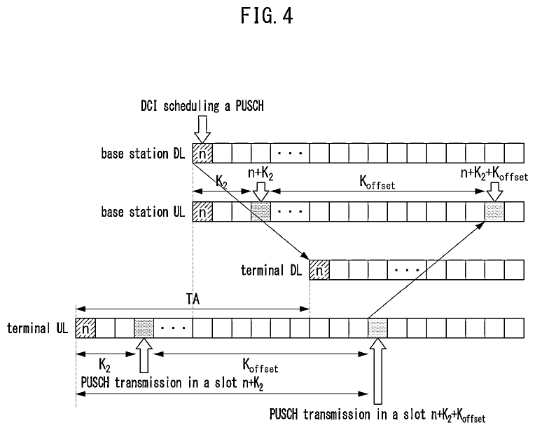

FIG. 4 is a conceptual diagram illustrating a first exemplary embodiment of uplink slots in a non-terrestrial network.

Referring to FIG. 4, a base station may transmit DCI for scheduling a PUSCH to a terminal. Then, the terminal may receive the DCI for scheduling the PUSCH from the base station. In this case, the terminal may receive the scheduling DCI in a downlink slot n. According to the received scheduling DCI, an uplink slot in which the terminal needs to transmit the PUSCH may be a slot n+K₂+K_{offset}. The scheduling offset K_{offset} for the PUSCH transmission timing may be applied to a timing of the following physical channels.
A transmission timing of a DCI scheduling-based PUSCH including channel state information (CSI) on the PUSCH
A transmission timing of a first PUSCH occasion based on a Type-1 configured grant (CG)
A transmission timing of a hybrid automatic repeat and request (HARQ)-acknowledgment (ACK) on a PUCCH
An uplink transmission timing adjusted according to a corresponding TA command
A transmission timing of aperiodic sounding reference signal (SRS)
A timing of a CSI reference resource

The scheduling offset K_{offset} may be used for timing relationship in initial random access. Therefore, the cell-specific scheduling offset K_{offset} may be signaled through system information. A range of the signaled cell-specific scheduling offset K_{offset} may be from 0 to 1023 ms so as to include all delay times of all types of satellite systems such as LEO and GEO satellites. On the other hand, an additional terminal (UE)-specific scheduling offset K_{offset} may be provided to accommodate terminal-specific propagation delay to improve scheduling efficiency, and may be updated by the network. In this case, the base station may not provide the UE-specific scheduling offset K_{offset} to the terminal as it is. Instead, the base station may provide a differential UE-specific scheduling offset K_{offset} to the terminal through a medium access control (MAC)-control element (CE). Accordingly, the UE-specific scheduling offset K_{offset} may be defined as a value obtained by subtracting the differential UE-specific scheduling offset from the cell-specific scheduling offset.

On the other hand, the base station may not provide the UE-specific scheduling offset K_{offset} to the terminal. Then, the terminal may use the cell-specific scheduling offset for all timings for which the scheduling offset K_{offset} is required. Alternatively, the base station may provide the UE-specific scheduling offset K_{offset} to the terminal. Then, the terminal may use the UE-specific scheduling offset K_{offset} for all timings for which the scheduling offset K_{offset} is required. However, the following channels may always use the cell-specific scheduling offset for all timings for which the scheduling offset K_{offset} is required.
A PUSCH timing based on random access response (RAR) grant scheduling
A retransmission timing of a Msg3 scheduled by a DCI format 0_0 with a cyclic redundancy check (CRC) scrambled by a temporary cell radio network temporary identifier (TC-RNTI)
A HARQ-ACK PUCCH transmission timing for a contention resolution PDSCH scheduled by a DCI format 1_0 with a CRC scrambled by a TC-RNTI
A HARQ-ACK PUCCH transmission timing for a MsgB scheduled by a DCI format 1_0 with a CRC scrambled by a MsgB-RNTI
PDCCH order physical random access channel (PRACH) transmission timing

A reason why the cell-specific scheduling offset K_{offset} is used in the above-described channels may be to eliminate ambiguity, since it is difficult to exchange information on the scheduling offset K_{offset} applied between the network and the terminal in the idle mode through a dedicated resource.

Meanwhile, the Release 17 NTN specifications have newly introduced an uplink timing control procedure to the existing NR specifications along with the newly added scheduling offset K_{offset}. This is because the uplink timing mechanism in the Release 16 NR specifications cannot accommodate the long round-trip delay time in the NTN channel environment. To address this issue, the Release 17 NTN specifications have added an uplink timing pre-compensation mechanism by the terminal. In order to support this uplink timing pre-compensation mechanism, NTN terminals may need capability to acquire their own location based on Global Navigation Satellite System (GNSS) information. In addition, the NTN terminal may need capability to predict a position and velocity of a satellite based on satellite ephemeris information shared by the network. The terminal with such capabilities may calculate a TA by applying a new TA calculation scheme, such as Equation 1 below, to improve the existing TA mechanism. The new TA calculated by Equation 1 may be a pre-compensated TA.

$$T A = ( {N}_{T A} + {N}_{TA , offset} + {N}_{TA , adj}^{c o mmon} + {N}_{T A , a d j}^{U E} ) \times {T}_{c} \qquad [ Equation 1 ]$$

Here, N_{TA} may be a common TA correction value. N_{TA.offset} may be a fixed TA offset that is fixed or promised in advance between the satellite and the terminal. T_{c} may be given as T_{c}=1/(Δfₘₐₓ·N_{f}). Δfₘₐₓ may be 480·10³ Hz, and Ne may be 4096. Here, N_{TA}, N_{TA.offset}, and T_{c} may be values defined the existing NR specifications. N^{common}_{TA,adj} may be a common TA adjustment value, which may be a value derived from satellite ephemeris-related higher layer parameters TACommon, TACommonDraft, and TACommonDriftVariation, if these parameter values are configured. Otherwise, N^{common}_{TA,adj} may have a value of 0. N^{UE}_{TA,adj} may be a UE-specific TA adjustment value, which may be a value calculated by the terminal based on the satellite ephemeris-related higher layer parameters if these higher layer parameters are configured. Otherwise, N^{UE}_{TA,adj} may have a value of 0. The newly added N^{common}_{TA,adj} may be a terminal-self estimated timing offset derived by the terminal from network-controlled parameters. N^{common}_{TA,adj} may be used for the purpose of compensating for a propagation delay commonly experienced between all terminals and the base station. In particular, this common propagation delay may include a propagation delay observed between a serving satellite and an uplink timing synchronization reference point considered by the network.

On the other hand, the newly added N^{UE}_{TA,adj} may be a timing offset estimated by the terminal based on the network-controlled parameters related to satellite ephemeris and the terminal's location acquired by the terminal itself. N^{UE}_{TA,adj} may be used for the purpose of compensating for the terminal-specific delay experienced in a service link between the terminal and the serving satellite. The satellite ephemeris information may be transmitted through a system information block 19 (SIB19) message.

The uplink transmission timing mechanism of Release 17 NTN may have the following two problems. First, the base station may not know information on a timing that the terminal has pre-compensated by itself (i.e. pre-compensated TA information). In this case, since the cell-specific scheduling offset K_{offset} needs to be applied, terminals with a short propagation delay within a cell (i.e. terminals located close to the satellite within the cell, e.g. terminals in a cell center region) may transmit uplink signals after waiting longer from a time of receiving a downlink signal than terminals with a long propagation delay within the cell (i.e. terminals located far from the satellite within the cell, e.g. terminals in a cell edge region). In other words, terminals with a short propagation delay may perform uplink transmission earlier than terminals with a long propagation delay. However, terminals with a short propagation delay may add an artificial delay by considering the propagation delay of terminals with a long propagation delay. As a result, a signal transmitted by the terminal with a short propagation delay may reach the satellite at the same time as a signal transmitted by the terminal with a long propagation delay. However, this may cause an unintended delay. This may occur when the terminal is in idle mode rather than RRC connected mode, and may occur especially during random access. Accordingly, the artificial delay may occur in random accesses of terminals with relatively small intra-cell propagation delays.

To solve the above-described problem, the terminal may apply a UE-specific scheduling offset K_{offset} to an uplink transmission timing. To this end, the base station may require information on a pre-compensated TA (or N^{UE}_{TA,adj} information) calculated by the terminal based on the ephemeris information of the satellite and location information of the terminal. In this case, the base station may obtain the pre-compensated TA information from the terminal. Accordingly, the base station may request the terminal to transmit the pre-compensated TA information. When the terminal receives the request for pre-compensated TA information from the base station, the terminal may transmit the pre-compensated TA information to the base station in response. Then, the base station may receive and obtain the pre-compensated TA information from the terminal. As described above, an additional procedure may be required for the base station to obtain the pre-compensated TA information from the terminal. Resource(s) and channel(s) for the additional procedure may need to be newly defined and added to downlink and uplink.

In order to solve these problems, the present disclosure proposes an uplink signal transmission method and device that can reduce random access delay in a mobile communication network having a wide cell coverage such as NTN, while increasing scheduling efficiency from the idle mode, and increasing the efficiency of resource usage and pre-compensated TA reporting procedure.

Accordingly, the present disclosure aims to propose an uplink signal transmission method in the NR/LTE-based mobile communication system for improving system performance while maintaining maximum compatibility with the existing NR/LTE in a cell size of 100 km or more in a radius. In addition, the present disclosure aims to propose an uplink signal transmission method for reducing random access delay time artificially caused by a propagation delay time difference between terminals within a cell in the satellite-based NTN such as GEO and LEO. In addition, the present disclosure aims to reduce additional signaling overhead while improving scheduling efficiency of the base station by implicitly reporting pre-compensated TA without defining a new pre-compensated TA reporting procedure in the idle mode.

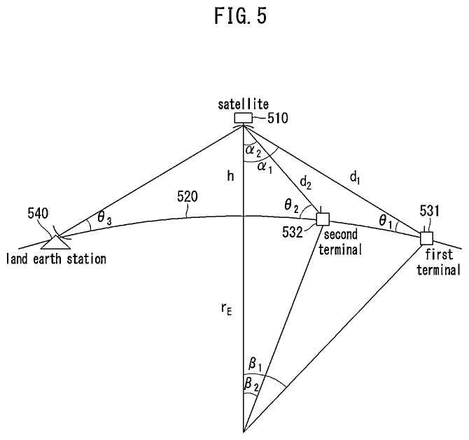

FIG. 5 is a conceptual diagram illustrating a first exemplary embodiment of a propagation delay time difference in a non-terrestrial network.

Referring to FIG. 5, h may be a height of a satellite 510, and r_{E} may be the earth radius 520. d₁ may be a distance between the satellite 510 and a first terminal 531, and d₂ may be a distance between the satellite 510 and a second terminal 532. α₁ may be an angle at which the first terminal 531 is located with respect to a vertical plane from the satellite 510, and α₂ may be an angle at which the second terminal 532 is located with respect to the vertical plane from the satellite 510. In this case, α₁-α₂ may be a spot beam angle α_{1,2} having a maximum size.

β₁ may be an angle at which the first terminal 531 is located with respect to a vertical plane from the center of the Earth 520, and β₂ may be an angle at which the second terminal 532 is located with respect to a vertical plane from the center of the Earth 520. β₁ may also be a first coverage angle of the satellite 510, and β₂ may also be a second coverage angle of the satellite 510. Accordingly, β₁-β₂ may be a spot beam coverage angle β_{1, 2} having a maximum size. θ₁ may be an elevation angle at the first terminal 531, θ₂ may be an elevation angle at the second terminal 532, and θ₃ may be an elevation angle at a land earth station (LES) 540. The elevation angle may be a minimum elevation angle.

The first terminal 531 and the LES 540 may be located at an edge of a coverage of the satellite 510. The second terminal 532 may be located at the innermost part of the coverage of the maximum spot beam of the satellite 510. A propagation delay time between the satellite 510 and the first terminal 531 may be t₁, and a propagation delay time between the satellite 510 and the second terminal 532 may be t₂. Accordingly, a propagation delay time difference Δt_{1,2} may be as shown in Equation 2 below.

$$Δ {t}_{1 , 2} = {t}_{1} - {t}_{2} \qquad [ Equation 2 ]$$

A relationship between the coverage angle βᵢ and the elevation angle θᵢ of the satellite 510 may be as shown in Equation 3 below, and i may be a natural number.

$${β}_{i} = arccos ( \frac{{r}_{E}}{{r}_{E} + h} cos {θ}_{i} ) - {θ}_{i} \qquad [ Equation 3 ]$$

For the maximum spot beam, a spot beam coverage diameter s_{1,2} along the ground surface may have a relationship with the maximum spot beam coverage angle β_{1,2} as shown in Equation 4 below.

$${s}_{1 , 2} = 2 π {r}_{E} \frac{{β}_{1 , 2}}{360 °} \qquad [ Equation 4 ]$$

A distance dᵢ between each terminal 531 or 532 and the satellite 510 may be as shown in Equation 5 below.

$${d}_{i} = \sqrt{{r}_{E}^{2} + {( {r}_{E} + h )}^{2} - 2 {r}_{E} ( {r}_{E} + h ) cos {β}_{i}} \qquad [ Equation 5 ]$$

Each propagation delay time tᵢ between each terminal 531 or 532 and the satellite 510 may be as shown in Equation 6 below. Here, c may be a speed of radio waves.

$${t}_{i} = {d}_{i} / c \qquad [ Equation 6 ]$$

A propagation delay time difference may vary depending on the altitude and spot beam coverage of the satellite 510. Currently, a random access channel format 1, which supports the largest cell in the NR system, can support up to 100 km of cell radius of the terrestrial mobile communication system. In contrast, considering a GEO satellite currently being considered for NTN and an elevation angle of 40° at which Korea is located, the NTN system can support only up to 75 km of cell radius. The NTN system can maximize the overall system capacity by minimizing the size of multiple beams. In addition, the NTN system can increase the data transmission capacity by reducing the length of cyclic prefix (CP) and guard period (GT) in random access channels. Considering this, it may be efficient for the NTN system to make the satellite beam size small.

Therefore, in the NR-based NTN, the random access channel may transmit signals considering the cell size and low elevation angle of GEO satellites and LEO satellites that can be realistically considered in terms of current satellite antenna technology and system capacity. In this case, a round-trip delay time difference between a terminal closest to a satellite and a terminal farthest from the satellite may be up to 3.26 ms in a GEO satellite system with a cell size of 500 km. In addition, a round-trip delay time difference between a terminal closest to a satellite and a terminal farthest from the satellite may be up to 1.308 ms in a LEO satellite system with a cell size of up to 200 km. In the NR-based NTN, the random access channel may need to support this round-trip delay time difference.

In order to accommodate such propagation delay time differences, the Release 17 NTN specifications allow the terminal to compensate for the propagation delay time difference in advance based on the satellite ephemeris and its own location information. By compensating for the propagation delay time difference in advance, uplink signals transmitted from the terminals within the cell may simultaneously reach the base station within a range allowed by the existing NR specifications (e.g. within the CP length). Accordingly, the terminals can acquire uplink synchronization without changing the existing NR specifications.

To this end, in the random access, the terminal may estimate a propagation delay time at the terminal's location based on the satellite ephemeris and its own location information. In this case, the base station may provide the terminal with a reference propagation delay time (e.g. cell-specific scheduling offset K_{offset}. Accordingly, the terminal may calculate a difference between the estimated propagation delay time and the reference propagation delay time. Then, the terminal may transmit a random access preamble to the base station at an earlier time corresponding to the calculated time difference. In this case, the base station may receive the random access preambles from the terminals within a random access preamble CP of the existing NR. As described above, the base station may receive the random access preambles from the terminals in the same manner as the method and procedure for receiving the random access preamble specified in the existing NR specifications.

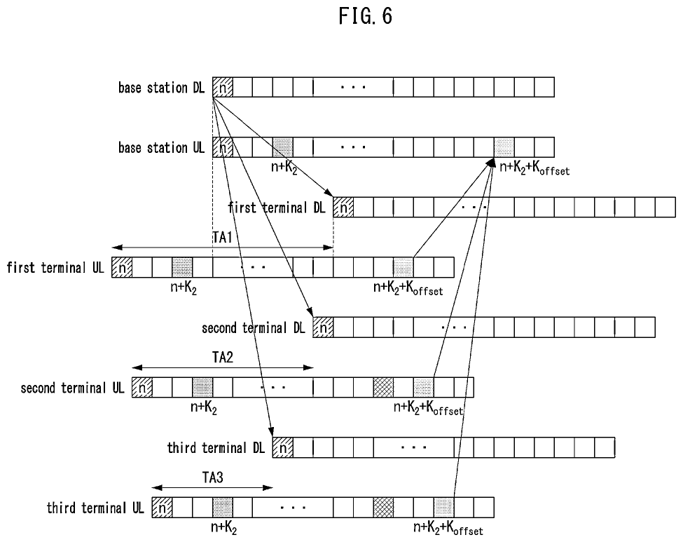

FIG. 6 is a conceptual diagram illustrating a second exemplary embodiment of uplink slots in a non-terrestrial network.

Referring to FIG. 6, a first terminal may be located in an area having a propagation delay time that is well matched to a reference propagation delay time provided by a base station. Accordingly, the first terminal may adjust an uplink timing by using a TA1 having a length similar to the reference propagation delay time (e.g. cell-specific scheduling offset K_{offset}). The first terminal may adjust the uplink timing by using the TA1 that is longer than other terminals within the cell. Accordingly, the first terminal may transmit an uplink signal or random access preamble to the satellite immediately n+K₂ slots after receiving a signal in the n-th slot.

On the other hand, a second terminal may be located in an area having a propagation delay time that is well matched to a propagation delay time that is about 1 slot shorter than the reference propagation delay time. In this case, a TA2, which is a TA used by the second terminal, may be smaller than the TA1, which is the TA used by the first terminal. Accordingly, an uplink signal transmitted by the second terminal may reach the base station at the same time as the uplink signal transmitted by the first terminal. To this end, the second terminal may transmit an uplink signal or random access preamble immediately n+2+K₂ slots after receiving a signal in the n-th slot. This means that in the case of the existing NR specifications, the second terminal transmits the signal immediately n+K₂ slots after receiving a signal in the n-th slot. In comparison, it can be seen that a transmission delay corresponding to 2 slots occurs due to uplink synchronization at the base station due to the propagation delay time difference.

Meanwhile, a third terminal may be located in an area having a propagation delay time that is well matched to a propagation delay time that is about 2 slots shorter than the reference propagation delay time. In this case, a TA3, which is a TA used by the third terminal, may be smaller than the TA1, which is the TA used by the first terminal. In addition, the TA3, which is the TA used by the third terminal, may be smaller than the TA2, which is the TA used by the second terminal. Accordingly, an uplink signal transmitted by the third terminal may reach the base station at the same time as the uplink signal transmitted by the first terminal. In addition, the uplink signal transmitted by the third terminal may reach the base station at the same time as the uplink signal transmitted by the second terminal.

To this end, the third terminal may transmit an uplink signal or random access preamble to the base station immediately n+4+K₂ slots after receiving a signal in the n-th slot. This means that in the case of the existing NR specifications, the third terminal transmits the signal immediately n+K₂ slots after receiving a signal in the n-th slot. In comparison, a transmission delay corresponding to 4 slots may occur due to uplink synchronization at the base station due to the propagation delay time difference.

In other words, for a terminal having a propagation delay time similar to the reference propagation delay time, the occurrence of transmission delay may be minimal during uplink transmission or random access preamble transmission. On the other hand, for a terminal having a propagation delay time that is significantly different from the reference propagation delay time, the occurrence of transmission delay may be large during uplink transmission or random access preamble transmission. In the existing Release 17 NTN specifications, a transmission delay may inevitably occur in the idle mode including random access. This transmission delay may reduce the scheduling efficiency of the base station.

The present disclosure proposes an uplink signal transmission method that can increase scheduling efficiency and reduce transmission delay when using a cell-specific scheduling offset K_{offset} occurring in the Release 17 NTN specifications. In addition, the present disclosure proposes an uplink signal transmission method that can increase scheduling efficiency and reduce transmission delay when the terminal does not report TA information to the base station. To this end, the terminal may not wait for a TA reporting request from the base station in the existing RRC connection mode to report TA information to the base station. In addition, the terminal may notify the base station of pre-compensated TA information based on satellite ephemeris information and its own location information when transmitting a random access preamble. In this case, since the terminal is not in the RRC connection mode during the random access phase, it may be difficult to explicitly report the pre-compensated TA information to the base station. Therefore, the terminal may implicitly report the pre-compensated TA information to the base station.

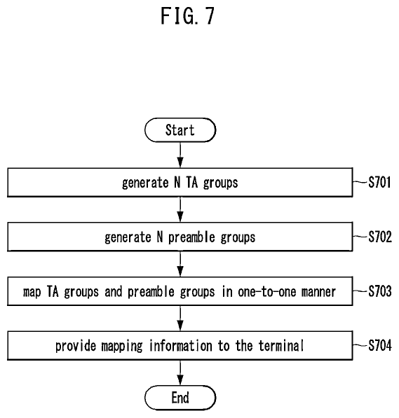

FIG. 7 is a flowchart illustrating a first exemplary embodiment of a method for providing mapping information between TA group and preamble group to a terminal.

Referring to FIG. 7, a base station may configure a TA range (or N^{UE}_{TA,adj} range) for TAs that can occur within one cell. Then, the base station may divide the TA range (or N^{UE}_{TA,adj} range) into groups each having a specific unit size to generate N TA groups (or N N^{UE}_{TA,adj} groups) (S701). Here, the specific size may be a random access preamble CP length of the NR. Alternatively, the specific size may be a slot length. Alternatively, the specific size may be a frame length. Here, the base station may configure a reference propagation delay time such as a group-specific scheduling offset K_{offset}, group for each of the N TA groups (or N N^{UE}_{TA,adj} groups). Then, the base station may group usable random access preambles into N preamble groups each having a specific number of preambles (S702). Here, the specific number may be determined according to the number of usable preambles in one cell and the size of N. For example, if the base station can use 64 preambles in one cell and has 8 groups, each preamble group may include 8 random access preambles.

The base station may map the N TA groups (or N^{UE}_{TA,adj} groups) and N preamble groups in one-to-one manner, so that one TA group (or one N^{UE}_{TA,adj} group) corresponds to one preamble group (S703). By mapping one preamble group to one TA group (or N^{UE}_{TA,adj} group) as described above, the base station may implicitly determine information on a TA used by a terminal from a random access preamble used by the terminal. To this end, the base station may transmit mapping information between the TA groups (or N^{UE}_{TA,adj} groups) and the preamble groups to the terminal (S704). In this case, the base station may transmit information on a group-specific scheduling offset K_{offset,group} configured for each of the N TA groups (or N N^{UE}_{TA,adj} groups) to the terminal.

Then, the terminal may receive the mapping information between the TA groups (or N^{UE}_{TA,adj} groups) and the preamble groups from the base station and identify the mapping relationship between the TA groups (or N^{UE}_{TA,adj} groups) and the preamble groups. In addition, the terminal may receive information on the group-specific scheduling offset K_{offset}, group configured for each of the TA groups (or N^{UE}_{TA,adj} groups) from the base station and identify the configured relationship between the TA groups (or N^{UE}_{TA,adj} groups) and the group-specific scheduling offsets K_{offset}, group.

As described above, the base station may provide the mapping information between the TA groups (or N^{UE}_{TA,adj} groups) and the preamble groups to the terminal through signaling. In this case, the base station may provide the mapping information to the terminal through system information such as SIB19. Alternatively, the base station may transmit the mapping information to the terminal through an RRC message. Alternatively, the base station may provide the mapping information to the terminal through a MAC CE. Alternatively, the base station may provide the mapping information to the terminal through DCI. Alternatively, a manager may store the mapping information of the TA groups (or N^{UE}_{TA,adj} groups) and the preamble groups, which is generated by the base station, in the terminal so that the terminal manages the mapping information.

In addition, the base station may provide configuration information of the TA groups (or N^{UE}_{TA,adj} groups) and the group-specific scheduling offsets K_{offset,group} to the terminal through signaling. In this case, the base station may provide the configuration information to the terminal through system information such as SIB19. Alternatively, the base station may transmit the configuration information to the terminal through an RRC message. Alternatively, the base station may provide the configuration information to the terminal through a MAC CE. Alternatively, the base station may provide the configuration information to the terminal through DCI. Alternatively, the manager may store the configuration information of the TA groups (or N^{UE}_{TA,adj} groups) and the preamble groups, which is generated by the base station, in the terminal so that the terminal manages the configuration information.

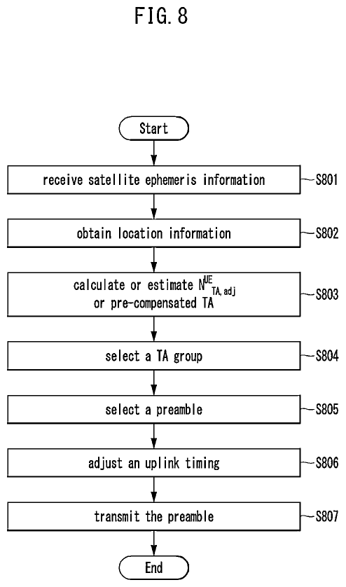

FIG. 8 is a flowchart illustrating a first exemplary embodiment of a method for transmitting an uplink signal in a non-terrestrial network.

Referring to FIG. 8, in an uplink signal transmission method in an NTN, a base station may transmit satellite ephemeris information to a terminal. Then, the terminal may receive the satellite ephemeris information from the base station (S801). Then, the terminal may obtain location information of the terminal by receiving global positioning system (GPS) signals from GPS satellites (S802). Then, the terminal may calculate or estimate a UE-specific TA adjustment value N^{UE}_{TA,adj} or a pre-compensated TA value based on the satellite ephemeris information obtained from the base station and its own location information (S803).

Then, the terminal may select a corresponding TA group from the TA groups based on the calculated or estimated UE-specific TA adjustment value or pre-compensated TA value (S804). Then, the terminal may select a preamble group mapped to the selected TA group and select one preamble from the selected preamble group (S805). Thereafter, the terminal may adjust an uplink timing based on a group-specific scheduling offset K_{offset,group} corresponding to the selected TA group or the existing cell-specific scheduling offset K_{offset} (S807). Then, the terminal may transmit an uplink signal including the selected preamble to the base station using the adjusted uplink timing (S807). Then, the base station may receive the uplink signal including the selected preamble from the terminal.

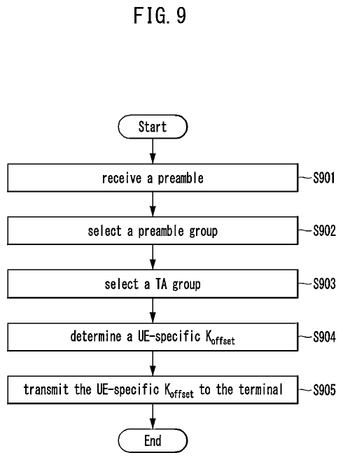

FIG. 9 is a flowchart illustrating a first exemplary embodiment of a method for receiving an uplink signal in a non-terrestrial network.

Referring to FIG. 9, the terminal may transmit the uplink signal including the selected random access preamble to the base station using the adjusted uplink timing. Then, the base station may receive the uplink signal including the selected random access preamble from the terminal (S901). Thereafter, the base station may select the preamble group including the random access preamble received from the preamble groups (S902). Then, the base station may select the TA group mapped to the preamble group from the TA groups (S903). Then, the base station may determine a UE-specific scheduling offset K_{offset} corresponding to the terminal based on the selected TA group and a group-specific scheduling offset K_{offset,group} configured for the TA group (S904). Then, the base station may transmit to the terminal information on the determined UE-specific scheduling offset K_{offset} by including it in a random access response message (S905). Then, the terminal may receive the random access response message including information on the determined UE-specific K_{offset} from the base station. Accordingly, the terminal may adjust the uplink timing using the determined UE-specific scheduling offset K_{offset} received from the base station and transmit the uplink signal to the base station using the adjusted uplink timing. As a result, the base station may receive, from the terminal, the uplink signal transmitted using the uplink timing adjusted based on the determined UE-specific scheduling offset K_{offset} received from the base station.

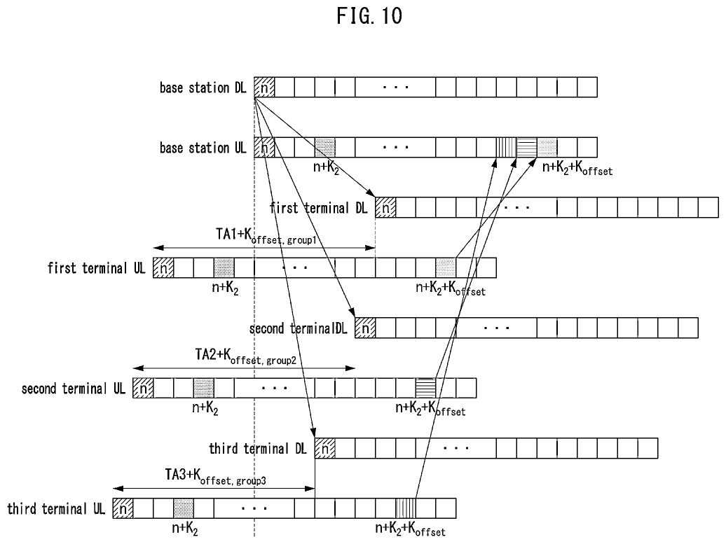

FIG. 10 is a conceptual diagram illustrating a third exemplary embodiment of uplink slots in a non-terrestrial network.

Referring to FIG. 10, a first terminal may be located in an area having a propagation delay time that is well matched to a reference propagation delay time provided by the base station. The first terminal may adjust an uplink timing by applying a group reference propagation delay time (e.g. group-specific K_{offset, group1}) applied to a preamble group 1 and TA group 1 (e.g. adding the group-specific K_{offset, group1} to a TA1) to adjust the TA1 belonging to the TA group 1. The first terminal may adjust the uplink timing using the adjusted TA1. Accordingly, the first terminal may transmit an uplink signal or random access preamble to the satellite immediately n+K₂+K_{offset} slots after receiving a signal in the n-th slot.

On the other hand, a second terminal may be located in an area having a propagation delay time that is well matched to a propagation delay time that is about 1 slot shorter than the reference propagation delay time. Accordingly, the second terminal may adjust an uplink timing by applying a group reference propagation delay time (e.g. group-specific K_{offset, group2}) applied to a preamble group 2 and TA group 2 (e.g. adding the group-specific K_{offset, group2} to a TA2) to adjust the TA2 belonging to the TA group 2. The second terminal may adjust the uplink timing using the adjusted TA2. Accordingly, the second terminal may transmit an uplink signal or random access preamble to the satellite immediately n+K₂+K_{offset} slots after receiving a signal in the n-th slot.

On the other hand, a third terminal may be located in an area having a propagation delay time that is well matched to a propagation delay time that is about 2 slots shorter than the reference propagation delay time. Accordingly, the third terminal may adjust an uplink timing by applying a group reference propagation delay time (e.g. group-specific K_{offset, group3}) applied to a preamble group 3 and TA group 3 (e.g. adding the group-specific K_{offset, group3} to a TA3) to adjust the TA3 belonging to the TA group 3. The third terminal may adjust the uplink timing using the adjusted TA3. Accordingly, the third terminal may transmit an uplink signal or random access preamble to the satellite immediately n+K₂+K_{offset} slots after receiving a signal in the n-th slot.

In this case, the first to third terminals may adjust the TAs by additionally reflecting the corresponding K_{offset}, group for each random access preamble group to the TA applied in the existing Release 17 NTN. In this case, since the random access Msg1 message can be transmitted immediately n+K₂ slots after receiving the n-th downlink slot regardless of the location of the terminal, as in the existing NR specifications, there may be an advantage of reducing transmission delay since the random access Msg1 message can be transmitted immediately without transmission delay.

As a result, FIG. 10 may be similar to the UE-specific K_{offset}-based timing relationship in the existing NR and NTN that can operate in the RRC connected mode. However, in the case of the TA adjustment of FIG. 10, since the base station needs to allocate slots for random access as many as N groups, if the size of N is large, the amount of resources allocated for random access may increase compared to the existing specification, and thus the amount of resources for data transmission may decrease. However, if the uplink timing is adjusted by the method of FIG. 10, there may be no need to implicitly transmit TA information through the random access preamble grouping. That is, as shown in FIG. 10, the base station may divide a range of TAs that may occur in the cell into groups, configure K_{offset,group} for each group, and provide TA range grouping information to the terminal directly without the random access preamble grouping step. The terminal may calculate or estimate a TA value, adjust an uplink timing based on a K_{offset}, group corresponding to a range of the estimated TA value, and transmit a preamble according to the adjusted uplink timing. Since a location of a random access slot received for each TA group is different, the base station may implicitly obtain TA information of the terminal transmitting the random access preamble while receiving the random access preamble in N receivable random access slots.

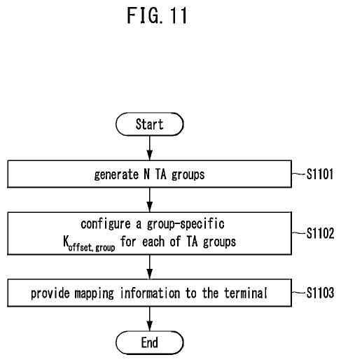

FIG. 11 is a flowchart illustrating a first exemplary embodiment of a method for providing mapping information between a TA group and a group-specific K_{offset,group} to a terminal.

Referring to FIG. 11, a base station may configure a TA range (or N^{UE}_{TA,adj} range) for TAs that may occur within one cell. Then, the base station may divide the TA range (or N^{UE}_{TA,adj} range) into N TA groups (or N N^{UE}_{TA,adj} groups) each having a specific unit size (S1101). Here, the specific unit size may be a random access preamble CP length of the NR. Alternatively, the specific unit size may be a slot length. Alternatively, the specific unit size may be a frame length. Here, the base station may configure a reference propagation delay time such as a group-specific scheduling offset K_{offset}, group for each of the N TA groups (or N N^{UE}_{TA,adj} groups) (S1102).

The base station may transmit mapping information between the TA groups (or N N^{UE}_{TA,adj} groups) and the group-specific scheduling offsets K_{offset}, group to the terminal (S1103). Then, the terminal may receive the mapping information between the TA groups (or N N^{UE}_{TA,adj} groups) and the group-specific scheduling offsets K_{offset,group} from the base station, and identify the mapping relationship between the TA groups (or N N^{UE}_{TA,adj} groups) and the group-specific scheduling offsets K_{offset}, group. As described above, the base station may provide the mapping information between the TA groups (or N N^{UE}_{TA,adj} groups) and the group-specific scheduling offsets K_{offset,group} to the terminal through signaling. In this case, the base station may provide the mapping information to the terminal through system information such as SIB19. Alternatively, the base station may transmit the mapping information to the terminal through an RRC message. Alternatively, the base station may provide the mapping information to the terminal through a MAC CE. Alternatively, the base station may provide the mapping information to the terminal through DCI. Alternatively, the manager may store the mapping information between the TA groups (or N N^{UE}_{TA,adj} groups) and the group-specific scheduling offsets K_{offset}, group, which is generated by the base station, in the terminal so that the terminal manages the mapping information.

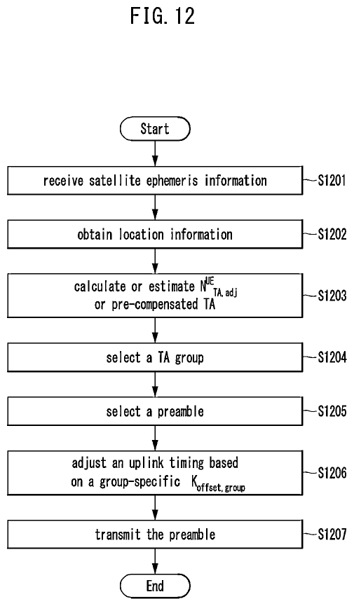

FIG. 12 is a flowchart illustrating a second exemplary embodiment of an uplink signal transmission method in a non-terrestrial network.

Referring to FIG. 12, in an uplink signal transmission method in an NTN, a base station may transmit satellite ephemeris information to a terminal. Then, the terminal may receive the satellite ephemeris information from the base station (S1201). Then, the terminal may obtain location information of the terminal by receiving GPS signals from GPS satellites (S1202). Then, the terminal may calculate or estimate a UE-specific TA adjustment value N^{UE}_{TA,adj} Or a pre-compensated TA value based on the satellite ephemeris information obtained from the base station and its own location information (S1203).

Then, the terminal may select a corresponding TA group from TA groups based on the calculated or estimated terminal-specific TA adjustment value or pre-compensated TA value (S1204). Then, the terminal may select an arbitrary preamble regardless of the selected TA group (S1205). Thereafter, the terminal may adjust an uplink timing based on a group-specific scheduling offset K_{offset,group} corresponding to the selected TA group (S1205). Then, the terminal may transmit an uplink signal including the arbitrary preamble to the base station using the adjusted uplink timing (S1207). Then, the base station may receive the uplink signal including the arbitrary preamble from the terminal.

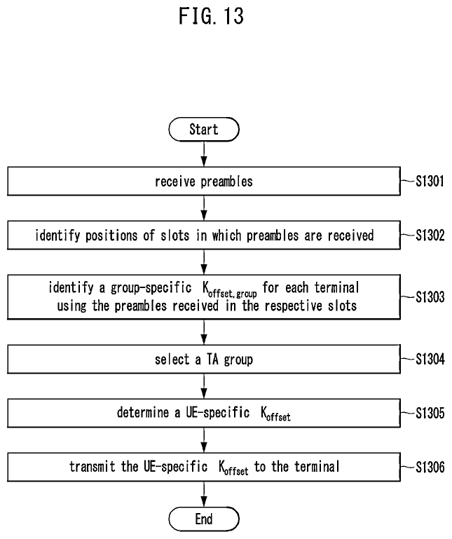

FIG. 13 is a flowchart illustrating a second exemplary embodiment of a method for receiving an uplink signal in a non-terrestrial network.

Referring to FIG. 13, terminals may transmit uplink signals including arbitrary random access preambles to the base station using adjusted uplink timings. Then, the base station may receive the uplink signals including the arbitrary random access preambles from the terminals (S1301). Thereafter, the base station may identify positions of slots in which the uplink signals including the random access preambles are received (S1302). Then, the base station may identify group-specific scheduling offsets K_{offset}, group for the terminals using the random access preambles received in the respective slots from the identified positions of the slots (S1303). Then, for each terminal, the base station may select a TA group mapped to a group-specific scheduling offset K_{offset,group} from the TA groups (S1304). The base station may determine a UE-specific scheduling offset K_{offset} corresponding to each terminal based on the selected TA group and the group-specific scheduling offset K_{offset}, group (S1304). Thereafter, the base station may transmit to the terminal information on the determined UE-specific scheduling offset K_{offset} by including it in a random access response message (S1305). Then, the terminal may receive the random access response message including the information on the determined UE-specific scheduling offset K_{offset} from the base station. Accordingly, the terminal may adjust an uplink timing using the UE-specific scheduling offset K_{offset} received from the base station and transmit an uplink signal to the base station using the adjusted uplink timing. As a result, the base station may receive, from the terminal, the uplink signal transmitted using the uplink timing adjusted based on the determined UE-specific scheduling offset K_{offset} received from base station.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, information on Timing Advance (TA) groups, which are divided into groups, each having a specific unit size, based on a range for TAs occurring within a cell, and information on group-specific scheduling offsets mapped to the TA groups;
calculating a pre-compensated TA based on satellite ephemeris information of the base station and location information of the terminal;
identifying a group-specific scheduling offset mapped to a TA group corresponding to the pre-compensated TA; and
transmitting a first uplink signal including a preamble to the base station using an uplink timing adjusted based on the group-specific scheduling offset.

2. The method according to claim 1, wherein the specific unit size is a unit of a random access preamble cyclic prefix (CP) length, slot length, or frame length.

3. The method according to claim 1, wherein the calculating of the pre-compensated TA comprises:
receiving the satellite ephemeris information from the base station;
obtaining the location information of the terminal by receiving global positioning system (GPS) signals from GPS satellites; and
calculating the pre-compensated TA using the satellite ephemeris information and the location information.

4. The method according to claim 1, wherein the transmitting of the first uplink signal comprises:
adjusting an uplink timing based on the group-specific scheduling offset to derive the adjusted uplink timing;
generating the first uplink signal including the preamble; and
transmitting the first uplink signal including the preamble to the base station using the adjusted uplink timing.

5. The method according to claim 1, further comprising: receiving information on preamble groups mapped to the TA groups from the base station, wherein the preamble is a preamble selected from a preamble group mapped to the TA group among the preamble groups.

6. The method according to claim 1, further comprising:
receiving a terminal-specific scheduling offset calculated based on the group-specific scheduling offset from the base station; and
transmitting a second uplink signal to the base station using an uplink timing adjusted based on the terminal-specific scheduling offset.

7. A method of a base station, comprising:
grouping Timing Advances (TAs) occurring within a cell into TA groups, each having a specific unit size, based on a range of the TAs;
generating group-specific scheduling offsets mapped to the TA groups;
transmitting, to a terminal, information on the TA groups and information on the group-specific scheduling offsets mapped to the TA groups; and
receiving, from the terminal, a first uplink signal including a preamble using an uplink timing adjusted based on the group-specific scheduling offset.

8. The method according to claim 7, wherein the specific unit size is a unit of a random access preamble cyclic prefix (CP) length, slot length, or frame length.

9. The method according to claim 7, further comprising:
identifying a position of a slot in which the first uplink signal is received;
estimating the group-specific scheduling offset based on the identified position of the slot;
calculating a terminal-specific scheduling offset based on the group-specific scheduling offset; and
transmitting the terminal-specific scheduling offset to the terminal.

10. The method according to claim 7, further comprising: receiving, from the terminal, a second uplink signal using an uplink timing adjusted based on the terminal-specific scheduling offset.

11. The method according to claim 7, further comprising:
grouping preambles used in the cell to generate preamble groups;
mapping the preamble groups to the TA groups; and
transmitting information on the preamble groups mapped to the TA groups to the terminal,
wherein the preamble is a preamble selected from a preamble group mapped to the TA group among the preamble groups.

12. The method according to claim 11, further comprising:
identifying the preamble group including the preamble of the first uplink signal;
estimating the group-specific scheduling offset based on the identified preamble group;
calculating a terminal-specific scheduling offset based on the group-specific scheduling offset; and
transmitting the terminal-specific scheduling offset to the terminal.

13. A terminal comprising a processor, wherein the processor causes the terminal to perform:
receiving, from a base station, information on Timing Advance (TA) groups, which are divided into groups, each having a specific unit size, based on a range for TAs occurring within a cell, and information on group-specific scheduling offsets mapped to the TA groups;
calculating a pre-compensated TA based on satellite ephemeris information of the base station and location information of the terminal;
identifying a group-specific scheduling offset mapped to a TA group corresponding to the pre-compensated TA; and
transmitting a first uplink signal including a preamble to the base station using an uplink timing adjusted based on the group-specific scheduling offset.

14. The terminal according to claim 13, wherein in the calculating of the pre-compensated TA, the processor further causes the terminal to perform:
receiving the satellite ephemeris information from the base station;
obtaining the location information of the terminal by receiving global positioning system (GPS) signals from GPS satellites; and
calculating the pre-compensated TA using the satellite ephemeris information and the location information.

15. The terminal according to claim 13, wherein in the transmitting of the first uplink signal, the processor further causes the terminal to perform:
adjusting an uplink timing based on the group-specific scheduling offset to derive the adjusted uplink timing;
generating the first uplink signal including the preamble; and
transmitting the first uplink signal including the preamble to the base station using the adjusted uplink timing.

16. The terminal according to claim 13, wherein the processor further causes the terminal to perform: receiving information on preamble groups mapped to the TA groups from the base station, wherein the preamble is a preamble selected from a preamble group mapped to the TA group among the preamble groups.

17. The terminal according to claim 13, wherein the processor further causes the terminal to perform:
receiving a terminal-specific scheduling offset calculated based on the group-specific scheduling offset from the base station; and
transmitting a second uplink signal to the base station using an uplink timing adjusted based on the terminal-specific scheduling offset.
